(19) United States
(12) Patent Application Publication
(10) Pub. No.: US 2022/0216766 A1
(43) Pub. Date: Jul. 7, 2022

(54) ELECTRIC MOTOR

(71) Applicant: TEXA DYNAMICS S.R.L., Monastier di Treviso (IT)

(72) Inventor: Bruno VIANELLO, Monastier di Treviso (IT)

(21) Appl. No.: 17/605,245

(22) PCT Filed: Apr. 23, 2020
(86) PCT No.: PCT/IB2020/053858

§ 371 Date: Oct. 21, 2021

(30) Foreign Application Priority Data
Apr. 23, 2019 (IT) 102019000006270

(51) Int. Cl. H02K 7/08; H02K 7/00; H02K 9/19

(52) U.S. Cl. CPC H02K 7/08; H02K 9/19; H02K 7/003

(57) ABSTRACT

An electric motor is described comprising a rotor, a shaft integral with the rotor to transfer torque to a load, a stator coaxially crossed by the shaft. To improve the thermal resistance, a plain bearing placed between the stator and the shaft, and a lubricating fluid circuit configured to transport lubricating fluid and wet a contact surface between the stator and the shaft with the fluid.

The present invention refers to an electric motor, in particular to an axial-flow electric motor. The invention also refers to the electric vehicle mounting the motor.

Electric vehicles, especially high-performance ones, have very powerful electric motors. Universally the motor shaft is coupled to the stator via a ball or roller bearing, which is not lubricated and is highly stressed. That's why after a certain mileage the bearing must be replaced.

The maintenance, which is expensive and unwanted, is also accelerated by another problem, typical of these motors: the bearing is at the center of the motor, where it is very difficult to achieve adequate cooling. Thermal stresses too shorten the life of the bearing.

The main object of the invention is to improve the present state of the art.

Another object of the invention is to make a motor that does not suffer from the aforementioned problems.

Another object of the invention is to make a motor with less maintenance.

Another object of the invention is to make a motor with better cooling.

In particular, the invention is directed to an axial-flow electric motor, i.e. a motor having windings that generate a magnetic flux with a polar axis parallel to the rotation axis of the rotor. This type of motor has more complex structure than radial-flow motors but, the power being the same, it is lighter and smaller.

At least one of these objects is achieved by what is stated in the attached claims; advantageous technical characteristics are defined in the dependent claims.

An electric motor is proposed comprising:

a rotor,

a shaft integral with the rotor to transfer torque to a load,

a stator crossed coaxially by the shaft,

a plain bearing (or bush) placed between the stator and the shaft, and

a lubricant fluid circuit configured to transport lubricant fluid and wet a contact surface between the stator and the shaft with the fluid.

In this way, between the stator and the shaft there forms a film of lubricating fluid which not only guarantees the relative rotation between the stator and the shaft with reduced friction but also removes heat from this interface. Another advantage is that the oil also cools the shaft and consequently heat can be removed from the rotating disks and magnets, which suffer from high temperatures.

The circuit may be built or composed in various ways.

According to a preferred embodiment, the circuit comprises a (first) channel inside the shaft with a(n) (first) outlet on said surface; from such outlet the fluid can arrive on and/or return from said surface. So the circuit structure is simpler and the shaft is exploited to convey the lubricating fluid to the plain bearing, which is in a little accessible point.

The lubricating fluid can come out of the outlet, wet the contact surface and come out from the bushing e.g. dripping down the stator.

In a variant, the circuit comprises a second channel inside the shaft with a second outlet on said surface spaced from the first outlet of the shaft; the circuit being configured in such a way that the fluid exits from the first outlet going onto said surface and enters the second outlet to leave said surface.

In a variant, the circuit comprises a (second) channel inside the plain bearing with a (second) outlet on said surface spaced from the first outlet of the plain bearing; the circuit being configured so that the fluid exits from the first outlet of the plain bearing moving onto said surface and enters the second outlet of the plain bearing to leave said surface.

According to a preferred embodiment, the circuit comprises a channel inside the plain bearing with an outlet on said surface. From said outlet the fluid can arrive onto—and/or return from—said surface.

In a variant, a or each channel inside the plain bearing is a pass-through channel which radially passes through the thickness of the plain bearing.

In a variant, the or each channel inside the shaft and/or the plain bearing is connected to, or in general the circuit comprises, a reservoir of lubricating fluid, which advantageously can e.g. act as a purification and/or cooling environment.

Advantageously, the reservoir of lubricating fluid is comprised in a casing of the motor, e.g. a cup, and the casing is preferably externally finned in correspondence of the reservoir.

In a variant, the motor comprises a pump for circulating the lubricant fluid within the circuit. In particular, the pump is connected to the shaft to be operated by the shaft itself. The pump could also be electric and/or external to the motor.

The pump could also bring the fluid directly to a cooling-down radiator.

Another aspect of the invention refers to an electric vehicle mounting the motor, e.g. a car, a truck, a lorry, or a ship. In these cases the motor must have substantial power and/or with considerable stress, ergo the advantages of the invention are particularly significant.

Further advantages will become clear from the following description, which refers to a preferred embodiment of a motor wherein:

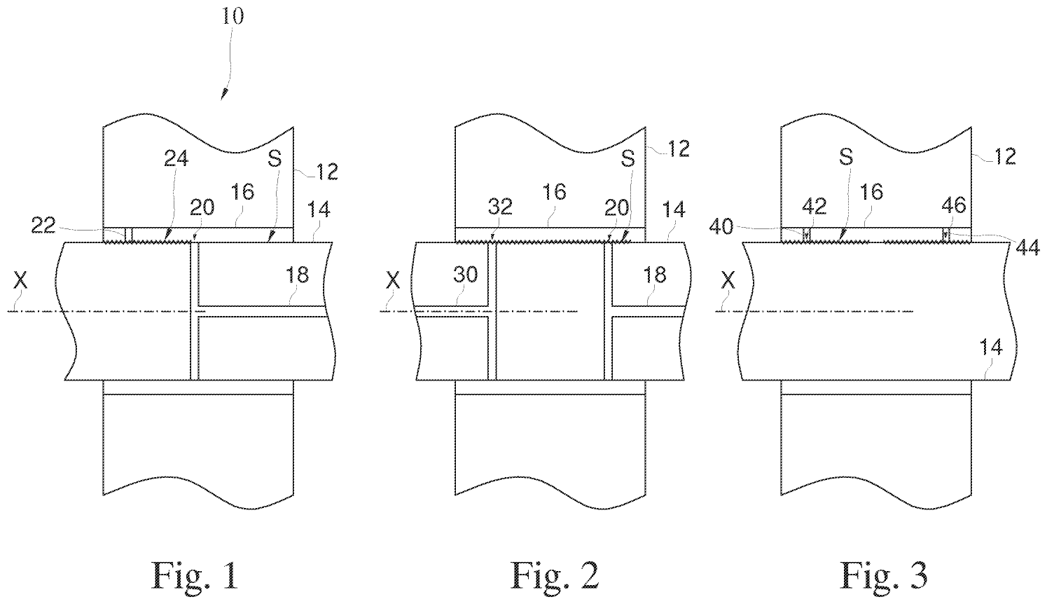

FIG. 1 shows a partial schematic view of an electric motor;

FIG. 2 shows a partial schematic view of a second electric motor;

FIG. 3 shows a partial schematic view of a third electric motor;

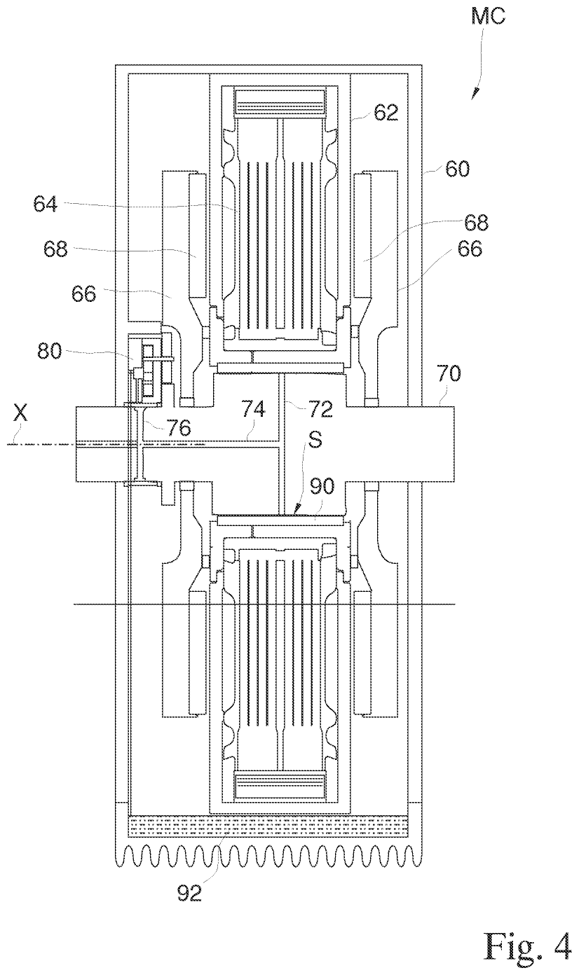

FIG. 4 shows a cross-sectional view of a fourth electric motor.

Equal numbers in the figures indicate equal or substantially equal parts.

FIG. 1 partially illustrates an electric motor 10 which comprises a shaft 14 integral with a rotor (not shown) and rotatable about an axis X. The shaft 14 coaxially crosses a stator 12 with which it couples by sliding on a plain bearing 16 arranged between the stator 12 and the shaft 14.

To transport a lubricating fluid (e.g. oil) and wet with the fluid a contact surface S between the stator 12 and the shaft 14, the shaft 14 comprises at least one internal channel 18 with an outlet 20 on the surface S. E.g. the channel 18 comprises a central axial segment, and one or more radial segments which from the central segment reach the lateral surface of the shaft 14.

From the outlet 20 the fluid can arrive onto—and/or return from—the surface S and form therein a film 24 of lubricant.

The plain bearing 16 comprises an internal channel 22 which radially crosses its thickness. The channel 22 has an outlet on the surface S for carrying fluid onto the surface S or to receive it from there.

The channel 18 and the channel 22 therefore form a circuit capable of circulating the lubricating fluid on the surface S.

FIG. 2 shows a different embodiment of such circuit.

The shaft 14 comprises a first internal channel 18 with an outlet 20 on the surface S and a second internal channel 30 with an outlet 32 on the surface S. The outlets 32, 20 are spaced from each other in the direction of the X axis

From the outlet 20 the fluid can arrive onto the surface S, forming a film 24 of lubricant, and can exit the channel 32.

FIG. 3 shows another embodiment of the fluid circuit.

Here the shaft 14 does not comprise internal channels.

The plain bushing 16 comprises a first radial internal channel 40 with an outlet 42 on the surface S and a second radial internal channel 44 with an outlet 46 on the surface S. The outlets 42, 46 are spaced from each other along the direction of the X axis.

From the outlet 42 the fluid can arrive on the surface S, form a film 24 of lubricant thereon, and exit from the channel 44.

The fluid circuits of FIGS. 1-3 may be e.g.

closed on a pump (not shown), capable of pushing the fluid within the channels; and/or

connected to suck and/or bring fluid back from/to a reservoir of fluid, advantageous because it ensures an uninterrupted fluid supply and because it allows cooling effectively the heated fluid arriving from the film 24.

FIG. 4 shows overall an electric motor MC which accomplishes completely the scheme of FIG. 1.

The motor MC is contained in a casing 60 from which a shaft 40, rotatable about an axis X, protrudes. The shaft 40 is integral with two rotors 66, from which it receives rotary torque, and coaxially crosses a stator 62, responsible for the rotation of the rotors 66.

The stator 62 e.g. comprises windings 64 for generating a magnetic field parallel to the axis X and capable of striking permanent magnets 68 mounted on the rotors 66, which are facing—and coaxial to—opposite sides of the stator 62.

The shaft 70 is slidingly coupled with the stator 62 by means of a plain bearing 90 placed between the stator 62 and the shaft 70.

The shaft 70 comprises an internal channel formed by a central coaxial segment 74, and one or more radial segments 72 which starting from the central segment 74 reach the lateral surface of the shaft 70 in contact with the plain bearing 90. The central segment 74 also communicates with one or more radial segments 76 which starting from the central segment 74 reach the lateral surface of the shaft 70 externally to the plain bearing 90 and to the rotors 66. The output of the one or more radial segment 76 is connected with a pump 80 supplied through a conduit by a reservoir of lubricating fluid 92 located at the base of the casing 60, which functions as a well-known oil pan in an internal combustion engine. Preferably the base of the casing 60 is finned, to better dissipate the heat of the fluid.

What described above allows transporting the lubricating fluid (e.g. oil) and wet with it the contact surface S between the stator 62 and the shaft 70.

In particular, the pump 80 circulates the fluid by withdrawing it from the reservoir 92, and injects it into a channel 76. From here the fluid runs through the channels 74 and 72, to arrive on the surface S where it spreads to form a thin film. When the fluid has covered the lateral surface of the plain bearing 90, it falls by gravity into specific ducts which are located under the walls of the stator 62 and returns to the reservoir 92.

The solutions shown in FIGS. 1, 2 and 3 can be used alone or in combination.

1. Electric motor (MC) comprising:
a rotor,
a shaft integral with the rotor to transfer torque to a load,
a stator coaxially crossed by the shaft,
a plain bearing placed between the stator and the shaft, and
a lubricating fluid circuit configured to transport lubricating fluid and wet a contact surface between the stator and the shaft with the fluid.

2. Motor according to claim 1, wherein the circuit comprises a first channel inside the shaft with a first outlet on said surface (S).

3. Motor according to claim 1, wherein the circuit comprises a first channel inside the plain bearing with an outlet on said surface (S).

4. Motor according to claim 3, wherein the circuit comprises a second channel inside the plain bearing with an outlet on said surface spaced from the first outlet of the plain bearing; the circuit being configured so that the fluid comes out of the first outlet of the plain bearing leading itself onto said surface and enters the second outlet of the plain bearing to leave said surface.

5. Motor according to claim 2, wherein the circuit comprises a second channel inside the shaft with a second outlet on said surface (S).

6. Motor according to claim 5, wherein the second channel is spaced from the first outlet of the shaft; the circuit being configured so that the fluid comes out of the first outlet of the shaft, moves onto said surface and enters the second outlet of the shaft to leave said surface.

7. Motor according to claim 3, wherein a or each channel inside the plain bearing is a pass-through channel that radially passes through the thickness of the plain bearing.

8. Motor according to claim 1, wherein the circuit comprises a reservoir of lubricating fluid.

9. Motor according to claim 8, wherein the reservoir of lubricating fluid is comprised in a casing of the motor, the casing being externally finned at the reservoir.

10. Motor according to claim 1, comprising a pump for circulating the lubricating fluid within the circuit.

11. Motor according to claim 2, wherein the circuit comprises a first channel inside the plain bearing with an outlet on said surface.

12. Motor according to claim 11, wherein the circuit comprises a second channel inside the plain bearing with an outlet on said surface spaced from the first outlet of the plain bearing; the circuit being configured so that the fluid comes out of the first outlet of the plain bearing leading itself onto said surface and enters the second outlet of the plain bearing to leave said surface.

13. Motor according to claim 12, wherein the circuit comprises a second channel inside the shaft with a second outlet on said surface (S).

14. Motor according to claim 6, wherein the second channel is spaced from the first outlet of the shaft; the circuit being configured so that the fluid comes out of the first outlet of the shaft, moves onto said surface and enters the second outlet of the shaft to leave said surface.

15. Motor according to claim 11, wherein a or each channel inside the plain bearing is a pass-through channel that radially passes through the thickness of the plain bearing.

16. Motor according to claim 4, wherein a or each channel inside the plain bearing is a pass-through channel that radially passes through the thickness of the plain bearing.
